(19) United States
(12) Patent Application Publication
(10) Pub. No.: US 2026/0365491 A1
(43) Pub. Date: Nov. 19, 2026

(54) A DEVICE FOR LIFTING AT LEAST ONE FLAT CEMENTITIOUS MATERIAL REINFORCEMENT PRODUCT

(71) Applicant: THE ROBERTS BV, Nieuwpoort (BE)

(72) Inventors: Daan GILLEMAN, Maarkedal (BE); Jan NOUWEN, Hellebecq (BE)

(21) Appl. No.: 19/514,978

(22) PCT Filed: Aug. 27, 2024
(86) PCT No.: PCT/EP2024/073874

§ 371 Date: Feb. 27, 2026

(30) Foreign Application Priority Data
Aug. 30, 2023 (EP) 23194306.9

(51) Int. Cl. B66C 1/62; E04G 21/16

(52) U.S. Cl. CPC B66C 1/62; E04G 21/169

(57) ABSTRACT

A device for lifting at least one cementitious material reinforcement product having a plurality of openings is provided. The device has a hoisting frame suitable for being secured to a hoisting means. The hoisting frame includes supporting elements, each having at least one supporting surface adapted to support at least one flat cementitious material reinforcement product, each of the supporting elements being positioned in such a way that when the hoisting frame rests on this at least one flat cementitious material reinforcement product, each supporting element is located in or above a respective opening. The supporting elements are configured to perform at least a first and a second movement, the first movement being a movement in a first direction towards, in or into the opening of this at least one flat cementitious material reinforcement product. The second movement is a movement for positioning the supporting surface of the supporting element under this at least one flat cementitious material reinforcement product in such a way that during lifting of the device, the supporting elements support the at least one flat cementitious material reinforcement product.

### FIELD OF THE INVENTION

The present invention generally relates to devices for lifting at least one flat cementitious material reinforcement product, and methods to move flat cementitious material reinforcement products.

### BACKGROUND OF THE INVENTION

Hardened cementitious materials, like concrete screed, mortar, and alike, are materials that can withstand high compressive stresses, but that are unable to withstand tensile stresses of the same order of magnitude. That is, cementitious material has a far higher compressive strength than tensile strength, which makes the material unsuitable in structures in which forces are distributed proportionally over tensile and compressive stresses.

However, to make cementitious material suitable for such structures, it is often to be combined with reinforcement products, usually metal rods, also called reinforcing rods, which have a coefficient of expansion that is almost identical to that of the cementitious material. This combined material, called reinforced cementitious material, like reinforced concrete, can withstand both high compressive and high tensile forces.

Cementitious material is usually reinforced on site or in a workshop, where the non-hardened, such as liquid, cementitious material and the reinforcement material are combined, embedding the reinforcement material in the non-hardened cementitious material, after which the hardening of the cementitious material takes place. Hence reinforcing of cementitious material can take place on site, for example on a building site, wherein the reinforcement rods are made to measure ad hoc by an operator, by shearing and bending them. However, this is a time-consuming task, so reinforcement is often prefabricated in a workshop and then transported to the building site.

Cementitious material reinforcement products may be prefabricated, e.g. steel reinforcement mat. This is a grid of metal rods, wherein a first set of parallel rods form a plane, and a second set of parallel rods is fastened permanently on top of this, wherein the direction of the first set differs from that of the second set. The permanent fastening consists, for example, of a welded joint.

Because cementitious material reinforcement products are usually fabricated at a location that differs from the building site where they will be used as reinforcement, the maximum size of the cementitious material reinforcement products is limited for reasons of transportability, and usually provided as flat cementitious material reinforcement products. For flat cementitious material reinforcement products to be transported efficiently, they are stacked and the whole stack is transported to the building site. Then at the building site, each flat cementitious material reinforcement product is fetched from the stack separately, and moved to the place where it will serve for reinforcement the cementitious material. Hoisting means and devices able to lift one or more such flat concrete reinforcement products are used.

An example of such a hoisting device or hoisting means is disclosed in BE1027413B1. This device is adapted for lifting a flat cementitious material reinforcement product which is supported by a hoisting frame. This hoisting frame comprises a number of supporting elements each having at least one supporting surface adapted to support a flat cementitious material reinforcement product. Each of the supporting elements is positioned in such a way that when the hoisting frame rests on this flat cementitious material reinforcement product, the supporting elements is located in a respective opening (and may move under the lower surface of the flat cementitious material reinforcement product.

However, stacked flat cementitious material reinforcement products may not always be stacked perfectly, and the stacked flat cementitious material reinforcement products sometimes tend to curve in the stack, having their sides being bended either upwards or downwards. To flatten out the stacked flat cementitious material reinforcement products, a force may be applied in a direction perpendicular to the surface of the upmost flat cementitious material reinforcement product in this stack. However devices of prior art may not always be able to execute these sufficiently large forces, e.g. by its own weight (when the hoisting frame is lifted by a crane or alike) or being pushed by a hoisting means being an excavator (like a bulldozer) or a lifting equipment (like a forklift) or alike. As such, in some situations, positioning the supporting surfaces of the supporting elements under the flat cementitious material reinforcement product may not always be feasible in a reliable and/or consistent way. This is a drawback of the devices of prior art, when the device is to grab a flat cementitious material reinforcement product from a stacks of flat cementitious material reinforcement products, where the flat cementitious material reinforcement products deviate from their flat or planar shape.

Consequently there is a need for a device for lifting one or more flat cementitious material reinforcement products from a stack safely and efficiently, wherein one or more of the above drawbacks are eliminated.

### SUMMARY OF THE INVENTION

According to a first aspect of the invention, a device for lifting at least one, and preferably only one, flat cementitious material reinforcement product is provided.

The device for lifting at least one, e.g. one, flat cementitious material reinforcement product comprising a plurality of openings comprises a hoisting frame suitable for being secured to a hoisting means. The hoisting frame comprises supporting elements, each having at least one supporting surface adapted to support at least one flat cementitious material reinforcement product, each of said supporting elements being positioned in such a way that when the hoisting frame rests on this at least one flat cementitious material reinforcement product, each supporting element is located in or above a respective opening. The supporting elements are configured to perform at least a first and a second movement, said first movement being a movement in a first direction towards, in or into the opening of this at least one flat cementitious material reinforcement product. The second movement is a movement for positioning the supporting surface of said supporting element under this at least one flat cementitious material reinforcement product in such a way that during lifting of the device, the supporting elements support the at least one flat cementitious material reinforcement product.

In the scope of the present invention, a hoist or hoisting means is to be understood as a device which is able to lift and carry a weight connected to the hoisting means. Hoisting means include tower cranes, like luffing tower cranes, crawler cranes, telescopic cranes, mobile or static cranes, truck cranes, lattice boom cranes and any other similar cranes, clacks, forklifts or excavators, like bulldozers and alike.

In the scope of the present invention, cementitious product and/or material refers to products in which a cement, either a hydraulic cement (such as Portland cement, a calcium, silica, alumina, and iron oxide mixture), a non-hydraulic cement, supplemental cementitious materials (SCM) like slag and fly ash, or a combination of one or more of those, acts as a binder, binding aggregates, such as stones, sand, gravel and alike. Examples of cementitious products and/or materials are amongst others concrete, screed, mortar and grout.

During the first movement, the supporting elements are positioned in the openings whereby the supporting surfaces are extending sufficiently through the opening in order to be able to contact the lower side of the flat cementitious material reinforcement product once the supporting elements make their second movement. During the second movement, the supporting surfaces are slid or rotated under the lower side of the flat cementitious material reinforcement product, beyond the edge of the opening. When the device is lifted, the supporting surfaces contact and support the lower side of the flat cementitious material reinforcement product, causing the flat cementitious material reinforcement product to move along with the device.

In the scope of the present invention, when reference is made to the lower side of a flat cementitious material reinforcement product, the side of the flat cementitious material reinforcement product oriented away from the hoisting means the device is connected to is meant. The opposite side of the lower side is indicated as the upper side. Usually the lower side is oriented downwards in the direction of the vertical, the upper side is oriented upwards in the direction of the vertical.

The device comprises a plurality of supporting elements, e.g. the deice may comprise 2, 3, 4 or even more, like 5, 6, 7, 8, 9 or 10 supporting elements. The supporting elements preferably are positioned in order to form the corners of a polygon. Most preferably the device comprises 3 to 6 supporting elements. Preferably, at least 3 of said supporting elements are positioned in order to form the corners of a triangle. More preferably, at least 4 of said supporting elements are positioned in order to form the corners of a rectangle or a square. Additional supporting elements may be positioned along the side of the polygonal, e.g. at about half of the length of a side of the polygonal.

Usually, the distance between adjacent supporting elements is in the range of 1 m to 12 m. According to some embodiments, the distance between the supporting elements may be adjustable. As a mere example, the distance between adjacent supporting elements is about 2480 mm to about 2780 mm, and adjustable within this range. This distance between the supporting elements may be adjustable in function of the dimensions of the flat cementitious material reinforcement product to be supported. Preferably the distance between the supporting elements is in the range of about half to about two third of the distance between the two edges of the flat cementitious material reinforcement product measured in the same direction as the direction between these two supporting elements.

According to some embodiments, the device may comprise at least four supporting elements, at least 3 of these supporting elements being positioned such they are positioned at the corners of a polygon.

According to some embodiments, the device comprises four supporting elements being positioned to form the corners of a rectangle, optionally being a square.

Most preferably the device comprises at least four supporting elements being positioned such they are positioned at the corners of a rectangle or a square. In case the flat cementitious material reinforcement product has a substantially rectangular perimeter, like in the case of a concrete reinforcement mat, also referred to as a rebar mesh or steel mat, comprising rebars crossing each other at right angles and defining mesh openings with usually uniform dimensions, the long side of the rectangle defined by the four supporting elements is substantially parallel, e.g. parallel to the long side of the perimeter of the rebar mesh, the short side of the rectangle defined by the four supporting elements is substantially parallel, e.g. parallel to the short side of the perimeter of the rebar mesh.

According to some embodiments, the supporting element may comprise a border at right angles to one side of its respective supporting surface. The supporting surface may be a planar surface, in particularly when the second movement is a translational movement. This supporting surface may be slid under the lower surface of the flat cementitious material reinforcement product. Alternatively, the supporting surface may be a planar or a curved surface, in particularly when the second movement is a rotational movement. This supporting surface may be rotated until the surface contacts the lower surface of the flat cementitious material reinforcement product.

In case the flat cementitious material reinforcement product is a steel reinforcement mat, the supporting surface may be slid or rotated such it contacts the lower side of the surface of one of the rebars in one of the two directions in which the rebars are present in the mat. The supporting surface may be slid or rotated such the foremost point of the supporting surface extends beyond the side of the contacted and supported rod or rebar which side is oriented away from the support element. The supporting element may further comprise an interlock configured to lock a supported rod on the supporting surface. The interlock may comprise a closing pin positioned, optionally at right angles, to the supporting surface, and configured to close the opening of the supporting element in which a supported rod is located.

The supporting elements may comprise one or more pairs of supporting elements. The first movements of these two supporting elements of this pair of supporting element are translational movements in an identical first direction in the same sense. The second movements of these two supporting elements of this pair of supporting element are translational movements in an identical second direction but in opposite sense. In case the supporting elements do not only contact the lower surface of the flat cementitious material reinforcement product, but also the edge of the opening of the flat cementitious material reinforcement product, e.g. the sides of the rebars forming the mesh opening in which the supporting element is positioned, this second translation may cause a force to be applied in a direction coplanar with the plane of the flat cementitious material reinforcement product. When such pair of supporting elements is used and each of the two supporting elements contact the edge of the opening it is positioned in, the mutually opposite forces may tension the flat cementitious material reinforcement product between the supporting elements and may flatten or stretch out the flat cementitious material reinforcement product during lifting.

In general the devices according to the first aspect of the invention, have the advantage that they enable to lift one (or optionally more than one) flat cementitious material reinforcement products from a stack of flat cementitious material reinforcement product, even when this stack is insufficiently properly stacked. Stacks of flat cementitious material reinforcement products, such as steel reinforcing mats, may have the tendency to bend to some extent, both having one side being bended downwards, or upwards. Hence the flat cementitious material reinforcement product may be positioned in a more curved way.

When the device is positioned on the upper surface of the flat cementitious material reinforcement product, the device may not press the flat cementitious material reinforcement product to its planar form sufficiently, when the device is connected to a hoisting means in a loosely hanging way, e.g. when hoisted by a tower crane, like a luffing tower crane, a crawler crane, a telescopic crane, a mobile or static crane, truck cranes, a lattice boom crane and any other similar cranes. Also when the device is connected rigidly to the hoisting means, e.g. to clacks, forklifts or excavator and alike, the hoisting means may not always be able to execute a sufficiently large force to the upper surface of the flat cementitious material reinforcement product in order to press the flat cementitious material reinforcement product to its planar form sufficiently. The provision of supporting elements which may make the at least the two movements, enable the device to lower or raise the supporting elements sufficient to bring the supporting surfaces at a position relative to the lower surface of the flat cementitious material reinforcement product such the supporting surface can contact this lower surface by making the second movement, even when the flat cementitious material reinforcement product is curved too much.

According to some embodiments, the first movement may be a translational movement in a first direction into the opening.

This first direction may be a direction perpendicular or substantially perpendicular to the plane defined by the flat cementitious material reinforcement product.

The length of the displacement of the supporting element in this first movement, is preferably in the range of 120 mm to 250 mm, e.g. in the range of 125 mm to 175 mm, such as about 150 mm. This length may be split in a section of the displacement above the nominal plane of the flat cementitious material reinforcement product, and a section of the displacement under the nominal plane of the flat cementitious material reinforcement product. The section above the nominal plane may be in the range of 10 mm to 75 mm, e.g. in the range of 25 mm to 75 mm, e.g. about 50 mm, whereas the section under the nominal plane may be in the range of 75 mm to 150 mm, e.g. in the range of 80 mm to 115 mm, e.g. about 100 mm.

The nominal plane of the flat cementitious material reinforcement product is the imaginary plane, parallel to the plane of the upper and lower surface of the flat cementitious material reinforcement product, at half the thickness of the flat cementitious material reinforcement product.

According to some embodiments, the second movement may be a translational movement in a second direction towards the edge of the opening.

This second direction may be a direction parallel or substantially parallel to the plane defined by the flat cementitious material reinforcement product. The length of the displacement of the supporting element in this second movement, is preferably in the range of 20 mm to 300 mm, e.g. in the range of 50 mm to 250 mm, as an example in the range of 100 mm to 200 mm such as about 150 mm.

Optionally, the supporting elements each may have a first and a second supporting surface, both adapted to support at least one flat cementitious material reinforcement product, both supporting surfaces are adapted to be brought under the flat cementitious material reinforcement product by a movement in the second direction, but in a different, optionally mutually opposite, sense. According to some embodiments, the second movement may be a rotational movement around an axis oriented in a third direction. Both supporting surfaces are adapted to be brought under the flat cementitious material reinforcement product by a movement, being a rotation in the second direction, possibly in the same rotation sense. Optionally, when the first movement is a translational movement in a first direction into the opening, this third direction may be identical or parallel to the first direction.

Optionally, the supporting elements each may have a first and a second supporting surface, both adapted to support at least one flat cementitious material reinforcement product, both supporting surfaces are adapted to be brought under the flat cementitious material reinforcement product by this movement in the second direction.

The supporting elements hence may be rotated between a first rotational position around the axis, in which the supporting surface are free of contact with the edge of the oping in which they are brought or positioned into, and a second rotational position around the axis, in which the supporting surface each are in contact with the edge of the opening in which they are brought or positioned into. The angle of rotation of the supporting surface in this second movement, is preferably in the range of 10° to 75°, such as in the range of 25° to 64°, e.g. about 45°.

Optionally the third direction may form an angle with the first direction, e.g. an angle of about 90°.

Optionally, when the first movement is a translational movement in a first direction into the opening, the third direction may be perpendicular to the first direction.

Possibly the supporting elements may be adapted to perform an identical first movement or to perform a first movement in the same direction, but possibly in a different sense.

The supporting elements may be adapted to perform the first movement synchronously.

According to some embodiments, the supporting elements may be adapted to perform the first movement one independent from the other.

Hence the supporting elements may be adapted to perform their first movements on a different time, in a different direction, in a different sense and/or over a different movement distance.

Possibly the supporting elements may be adapted to perform an identical second movement or to perform a second movement in the same direction, but possibly in a different sense.

The supporting elements may be adapted to perform the second movement synchronously.

According to some embodiments, the supporting elements may be adapted to perform the second movement one independent from the other.

Hence the supporting elements may be adapted to perform their second movements on a different time, in a different direction, in a different sense and/or over a different movement distance.

According to some embodiments, the device may comprise a first actuator for performing said first movement and a second actuator for performing said second movement. The actuators may be electric actuators, like electromotors, hydraulic or pneumatic actuators, or any other suitable kind of actuator known in the art. Preferably the actuators are hydraulic or pneumatic actuators. Possibly, the first actuator and the second actuator may be mutually independently operating hydraulic actuators.

In the scope of this invention, a flat cementitious material reinforcement product is to be understood as a reinforcement product which is adapted to be incorporated in a cementitious material structure in order to reinforce the cementitious material structure after being hardened. The term flat refers to the fact that the product, in general, is defined by a plane and is intended to be used in this planar shape, although when used, e.g. when lifted, the product may bend, e.g. under its own weight, to form a curved surface.

Preferably the flat cementitious material reinforcement product is a steel product. More preferably the flat cementitious material reinforcement product is a rebar mesh, also referred to as steel reinforcement mat or concrete reinforcement mat.

Such steel reinforcement mat is a grid of metal rods (also called rebars), wherein a first set of parallel rods form a plane, and a second set of parallel rods is fastened permanently on top of this, wherein the direction of the first set differs from that of the second set. The rods usually cross at right angles. The permanent fastening consists, for example, of a welded joint. As such, mesh openings are formed. The distance between adjacent rods of a set of rods is usually uniform over the surface of the steel reinforcement mat. The distances between adjacent rods of the sets of rods are usually identical.

Depending on the way in which a steel reinforcement mat is fabricated, a grid with square, rectangular or diamond-shaped meshes is provided. It is usual, for example, for a steel reinforcement mat to comprise rods of identical diameters in each direction, the distances between the rods in one plane to be identical, and the directions to be at right angles to each other. A grid with square meshes is typical, but another combination is also possible.

The diameters of rods typically are in the range of 3 to 50 mm, such as in the range of 3 to 25 mm, e.g. in the range of 6 to 12 mm. The diameters of rods are usually uniform for all rods used to provide the steel reinforcement mat,

The device according to the invention is adapted to lift at least one flat cementitious material reinforcement product at a time, although possibly the device according to the invention may be adapted to lift more than one, like 2, 3 or even more, flat cementitious material reinforcement product simultaneously. It is clear that to achieve this lifting of more than one flat cementitious material reinforcement product, the openings in the flat cementitious material reinforcement products are to be aligned such that each of the supporting elements may be positioned in such a way that when the hoisting frame rests on the upper of the more than one flat cementitious material reinforcement product, each supporting element can located in or above a respective series of aligned opening, aligned in the direction of the first movement.

According to some embodiments, the device may comprise one or more contact means configured to be secured to the hoisting frame such that the hoisting frame rests on the flat cementitious material reinforcement product or products by means of the contact means prior to the supporting elements making said first movement According to some embodiments, at least one dimension of the contact means may prevent the contact means to be able to pass in or into the opening of this at least one flat cementitious material reinforcement product.

According to some embodiments, the device further may comprise one or more contact means, such as base or press plates or base or press beams, configured to be secured to the hoisting frame in such a way that the hoisting frame rests on the flat cementitious material reinforcement product or products exclusively by means of the contact means, such as base plate or plates. At least one dimension of the contact means prevents the contact means to be able to pass openings in the flat cementitious material reinforcement product. The height of the contact means, such as base plate or plates, may be adjustable in such a way that the distance between the lower side of the contact means, such as plate or plates, and the upper side of the supporting surfaces may be tuned and set in function of the thickness of the flat cementitious material reinforcement product. The device may comprise a plurality of contact means, most preferably as much contact means as supporting elements. The contact means may be located adjacent to the supporting elements, preferably one adjacent each of the supporting elements. Each contact means may be located between two supporting elements, and preferably closer to one of the two supporting elements. Each contact means may be located between two supporting elements such the two supporting elements and said contact means are colinear.

Each contact means may be located adjacent a supporting elements such the supporting elements second movement is directed away from the contact means.

Such positions between supporting elements and the base plates, may cause the flat cementitious material reinforcement product to be flattened near the opening in which the supporting element is to be provided by the movements it needs to make. The flattening action may push the flat cementitious material reinforcement product to flatten in the direction and sense of the second movement. Once hoisted, this may cause the flat cementitious material reinforcement product to be inclined to move in opposite direction hence towards the supporting element, which may cause a more secure and guaranteed the positioning of the flat cementitious material reinforcement product on the supporting elements to a larger extent.

By the flattening effect, the distance of the first movement of the supporting element may to some extent be reduced, hence the working speed of the device may be increased, as less time may be needed to the supporting element to make the movements.

According to some embodiments, the hoisting frame may comprise two parallel side beams connected by means of connecting beams, each of the two parallel side beams comprising a supporting element at each end. The hoisting frame may comprise a coupling for coupling to the hoist. This coupling may be configured to connect the hoisting frame rigidly to the hoisting means, or to connect the hoisting frame loosely hanging to the hoisting means.

The device, in particularly the first and second movement, may be controlled in order to support and lift the at least one, e.g. only one flat cementitious material reinforcement product. The movements may be manually controlled by an operator, who may control the movement by providing signals to a control unit being part of the device or the hoisting means to which the device is connected. This provision of signals may be done by wired communication between the control unit and a controller, or by wireless control using a remote controller providing radioed instructions or coded signals to the control unit. The control may as well be semi-automatic or automatic, using appropriate sensors to control e.g. the movement of the supporting surfaces in detail, or the supporting elements in general.

According to a second aspect of the invention, a hoisting means is provided, said hoisting means comprising a device according to the first aspect of the invention. The hoisting means or hoist may be a tower crane, like a luffing tower crane, a crawler crane, a telescopic crane, a mobile or static crane, truck cranes, a lattice boom crane and any other similar cranes. For such hoisting means, the hoisting frame preferably is loosely hanging to the hoisting means. Also other hoisting means or devices can be used, like clacks, forklifts or excavator and alike. For such hoists, the hoisting frame preferably is rigidly connected to the hoisting means.

According to a third aspect of the present invention, a method to move a flat cementitious material reinforcement product is provided. This method comprises the steps of
1) providing a stack of the flat cementitious material reinforcement product;
2) providing
   a) a device according to the first aspect of the invention and connecting this device to a hoisting means, or
   b) a hoisting means according to the second aspect of the invention;
3) contacting the device to the upper surface of the upper flat cementitious material reinforcement product in the stack of flat cementitious material reinforcement product;
4) adjusting the position of some or all the supporting elements by making said first movement;
5) making the second movement for some or all the supporting elements;
6) lifting the device, while this device is supporting at least this upper flat cementitious material reinforcement product.

The hoisting means may move the lifted device, supporting at least this upper flat cementitious material reinforcement product, and optionally more than one flat cementitious material reinforcement product to a position on a construction yard. The hoisting means may lower the device and lifted flat cementitious material reinforcement product or products and release the lifted flat cementitious material reinforcement product or products, preferably when the device is placed on the ground level of this construction yard.

Hence according to some embodiments, the method further may comprise the steps:
7) move the lifted device, to a position on a construction yard;
8) lower the device and release the lifted flat cementitious material reinforcement product or products;
9) lift the device and move it back to the remainder of the stack of the flat cementitious material reinforcement product;
10) contacting the device to the upper surface of the upper flat cementitious material reinforcement product in the stack of flat cementitious material reinforcement product;
11) optionally adjusting the position of some or all the supporting elements by making said first movement;
12) making the second movement for some or all the supporting elements;
13) lifting the device, while this device is supporting at least this upper flat cementitious material reinforcement product;
14) optionally iterate steps 7 to 13 until all flat cementitious material reinforcement product or products of the stack of flat cementitious material reinforcement products are moved.

### BRIEF DESCRIPTION OF THE DRAWINGS

FIGS. 1, 2 and 3 illustrate schematically a device for lifting a flat cementitious material reinforcement product from a stack of flat cementitious material reinforcement products.

FIG. 4a to 4c illustrate schematically of a supporting element of the device according to the invention, in three different phases of a lifting operation.

FIG. 5 illustrates schematically a detail of an alternative supporting element of the device according to the invention.

FIGS. 6a and 6b, 7a and 7b, 8a and 8b and 9a and 9b show details of an alternative supporting element of the device according to the invention.

In the different figures, the same references refer to the same or a similar feature.

### DETAILED DESCRIPTION OF EMBODIMENT(S)

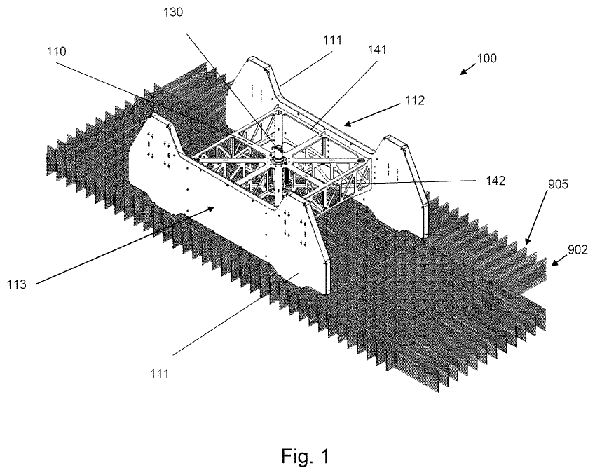

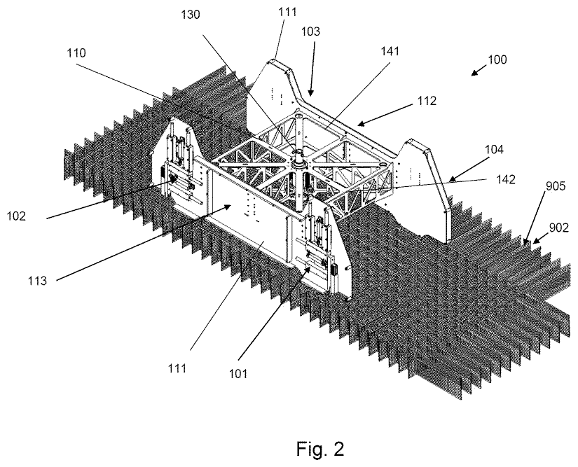

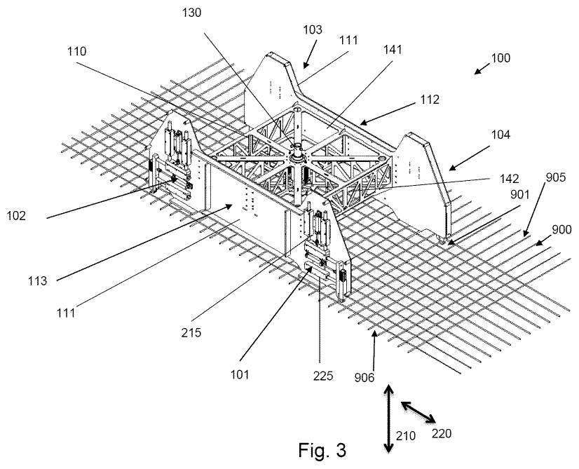

A device 100 for lifting a flat cementitious material reinforcement product 900 from a stack 902 of flat cementitious material reinforcement products is shown in FIG. 1. The device 100 rests on a stack 902 of flat cementitious material reinforcement products, in this case a stack of rebar meshes. FIG. 2 shows the device 100 in the same position, with the outer of the protection plates 111 removed. In FIG. 3, only the upper flat cementitious material reinforcement product 900, hence the upper rebar mesh is shown. FIG. 3 shows the flat cementitious material reinforcement product 900 when being gripped or supported by the device 100, when the flat cementitious material reinforcement product 900 is resting on the stack 902, or during lifting and moving of this flat cementitious material reinforcement product 900 by the device 100.

As is visible in FIG. 3, the flat cementitious material reinforcement product 900 comprises a plurality of openings 901, being the mesh openings of the rebar mesh.

The device 100 comprises a hoisting frame 110 which is suitable for being secured to a hoisting means (not shown) by means of a coupling 130. The coupling may be adapted to couple the frame to the hoisting means in a locked or fixed way. In these embodiments, the hoisting means is preferably a moveable device having an arm to which the device is locked, the arm being fully controllable in its movements in at least two or even more, like three dimensions. Examples of such moveable device are bulldozers or other excavators, or forklifts or alike. The device 100, coupled to this hoisting means, may be moved by moving the arm and even may be rotated in a controlled way round the coupling 130. Alternatively the coupling 130 may be adapted to couple the frame to the hoisting means in a loosely hanging way, e.g. connected while hanging on the load line of a crane.

The hoisting frame 110 comprises in this embodiment lateral beams 141 being connected with connecting beams like traverse beams 142 and/or diagonal beams 145. These beams together form a sturdy, rigid frame 110 which can bear the load of the flat cementitious material reinforcement product or products 900 to be lifted, its own weight as well as the weight of the other elements of the device 100.

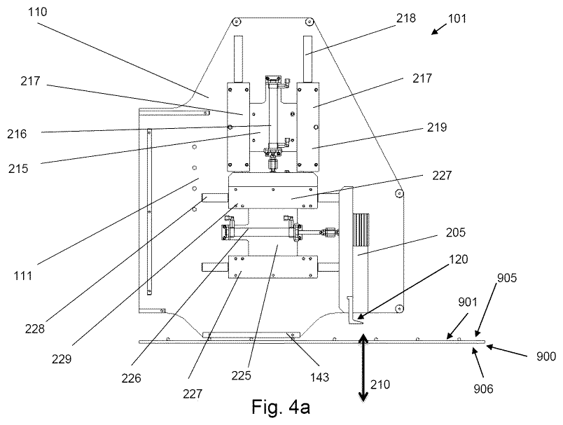

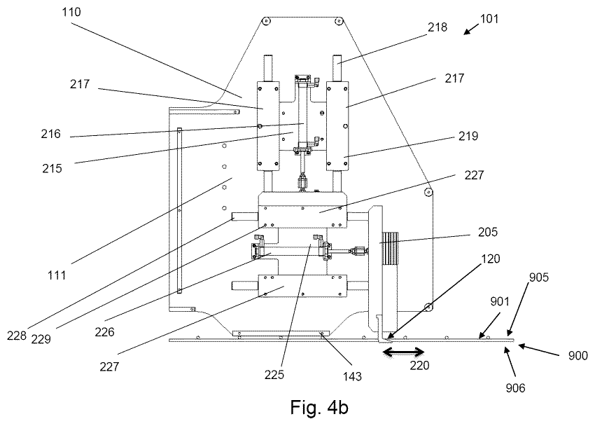

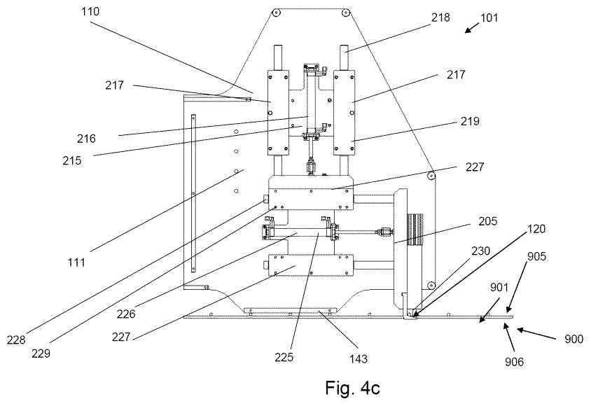

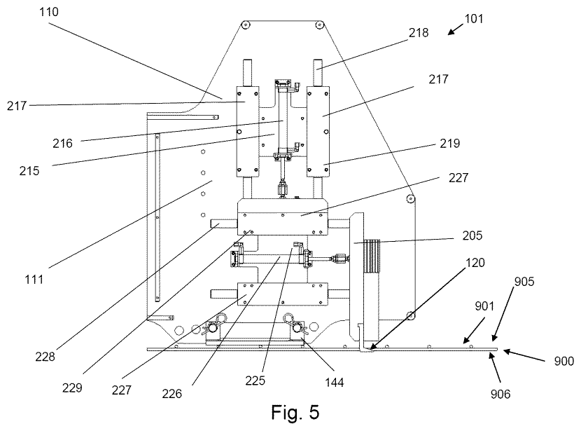

More details of the device 100, presented in different intermediate positions during picking up of a flat cementitious material reinforcement product 900, are shown in FIGS. 4a, 4b and 4c. As shown in these three figures, the frame 110 may contact and rest on the upper surface 905 of the flat cementitious material reinforcement product 900 by means of a contact means, in this case a base plate 143. FIG. 5 shows the same position of the frame as in FIG. 4b, where the frame comprises an adjustable contact means, in this case an adjustable base plate 144, the plates lower surface (to contact the flat cementitious material reinforcement product 900) being adjustable in height in view of the other parts of the frame 110. There are as much contact means as there are supporting elements. Adjacent each supporting element, there is a base plate near the supporting element, and oriented such it is colinear with the line between two adjacent supporting elements. The close position between supporting element and the base plate, may cause the flat cementitious material reinforcement product 900 to be flattened near the opening in which the supporting element is to be provided by the movements it needs to make. As such the distance of movement of the supporting element may to some extent be reduced.

As shown in FIGS. 1 to 3, the device 100 comprises in this embodiment four supporting elements (101, 102, 103 and 104), which are identical provided they may be mirrored to each other. Details of the supporting element 101 being an example of these four supporting elements, are shown in FIGS. 4a, 4b, 4c and 5. These four supporting elements are positioned at the corners of a rectangle, whose sides are parallel to the sides of the rectangular perimeter of the flat cementitious material reinforcement product 900.

Each of the four, substantially identical supporting elements, has in this embodiment one supporting surface 120 at the lower side of a moveable carrying means 205, e.g. a stick or finger. As shown in FIG. 4c, the support surface 120 is adapted to support a flat cementitious material reinforcement product 900 by supporting one of the rebars at the side of the lower side 906 of the rebar mesh.

Each of the supporting elements (101-104) are positioned in such a way that, when the hoisting frame rests on this flat cementitious material reinforcement product 900 as shown in FIGS. 4a, 4b, 4c and 5, each supporting element (101-104) is located in or above a respective opening 901, in this embodiment in or above a mesh opening. To enable the device to lift different kinds of flat cementitious material reinforcement product 900, e.g. different types of rebar meshes, with mesh openings and/or rebar diameters of different dimension, the mutual distances between the supporting elements (101-104) may be provided adjustable, e.g. by adjusting the position of the supporting elements (101-104) on the frame 110, or by having a frame with adjustable beams.

As shown in FIGS. 4a and 4b, the supporting elements (101-104) are configured to perform a first movement being a translation in a first direction 210, whereby the supporting surface 120 being located at the end of the moveable carrying means 205, can move in or into the opening 901. As shown by the FIGS. 4a and 4b, to change the position of the supporting surface 120 from the one shown in FIG. 4a to the one in FIG. 4b, an actuator 216 may move the supporting surface according to a translation, together with the moveable carrying means 205 and the second actuator 225, downwards, such the supporting surface is brought through the opening 901 to the lower side of the flat cementitious material reinforcement product 900. In this embodiment the actuator comprises a hydraulic piston 216 which presses to the upper side of the actuator 225. The translation is guided by two guide units 217, one at each side of the piston 216 and being parallel to the piston 216. Each guide unit 217 comprises a guide shaft 218 sliding through a fixed bearing block 219.

As shown in FIGS. 4b and 4c, the supporting elements (101-104) are configured to perform a second movement being a movement in a second direction 220, whereby the supporting surface 120, already extending through the opening 901 and hance being present under the lower side 906 of the flat cementitious material reinforcement product 900, may move in the opening 901 towards the edge of the opening 901.

As shown by the FIGS. 4b and 4c, to change the position of the supporting surface 120 from the one shown in FIG. 4b to the one in FIG. 4c, an actuator 226 may move the supporting surface according to a translation, together with the moveable carrying means 205 sideways, such the supporting surface is brought under the lower side of the flat cementitious material reinforcement product 900, in this embodiment under the rebar defining the edge of the opening. In this embodiment the actuator comprises a hydraulic piston 226 which presses the moveable carrying means 205, e.g. the finger, sideways. The translation is guided by two guide units 227, one at each side of the piston 226 and being parallel to the piston 226. Each guide unit 227 comprises a guide shaft 228 sliding through a fixed bearing block 229.

As the supporting surfaces will contact the lower side of the flat cementitious material reinforcement product 900, during lifting of the device, the supporting elements (101-104) support the flat cementitious material reinforcement product. The flat cementitious material reinforcement product 900 is taken along with the device. The device can be lifted in order to individualise the upmost flat cementitious material reinforcement product 900 from the stack 902, may move the lifted flat cementitious material reinforcement product 900 to a different position on the construction yard, where the device may be lowered to a position whereby the flat cementitious material reinforcement product 900 is placed on the ground. The device may execute consecutively the second and first movement in opposite sense, whereby the flat cementitious material reinforcement product 900 is disconnected and no longer supported by the supporting surfaces 120 of the device. The device may be moved back to the stack 902 of flat cementitious material reinforcement products 900, where the steps as shown in FIGS. 4a to 4c are repeated to lift the next flat cementitious material reinforcement product 900 from the stack 902.

Alternatively, the steps as shown in FIGS. 4a to 4c are executed to lift and move the first flat cementitious material reinforcement product 900 from a stack 902 of flat cementitious material reinforcement products 900. The device can be lifted in order to individualise the upmost flat cementitious material reinforcement product 900 from the stack 902, may move the lifted flat cementitious material reinforcement product 900 to a different position on the construction yard, where the device may be lowered to a position whereby the flat cementitious material reinforcement product 900 is placed on the ground. The device may now execute the second movement in opposite sense, whereby the flat cementitious material reinforcement product 900 is disconnected and no longer supported by the supporting surfaces 120 of the device. The device may be moved back to the stack 902 of flat cementitious material reinforcement products 900. By not executing the first movement, the device may be positioned and placed in contact with the next upmost flat cementitious material reinforcement product 900 from the stack 902, while the supporting surfaces 120 may already extend through the opening and may be in the position as shown in FIG. 4b. Only in case the supporting surfaces 120 is not yet at the right height, a further first movement may take place to tune the position of the supporting surfaces 120. Once the position is correct, the second movement may take place and the next upmost flat cementitious material reinforcement product 900 from the stack 902 is lifted and moved as described above.

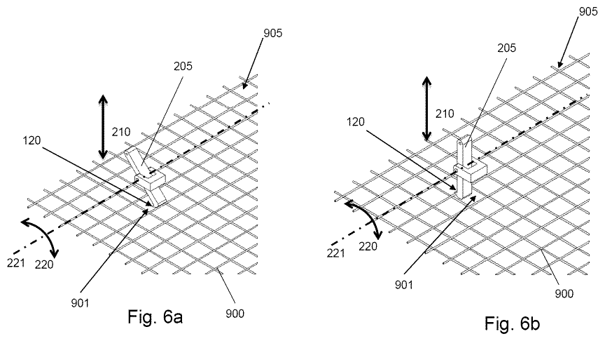

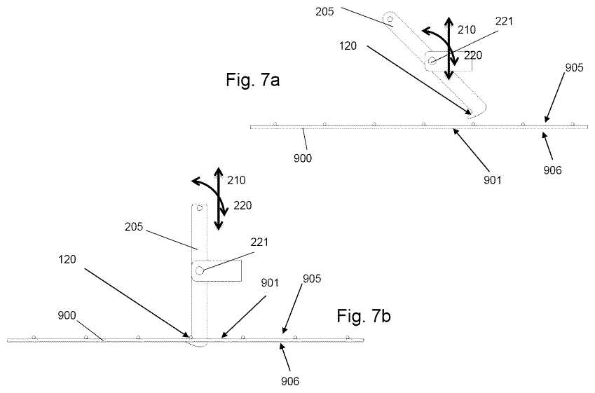

In FIGS. 6a and 6b, an alternative embodiment is shown for the moveable carrying means 205 having the supporting surface 120 at its outer end. A side view of the situation in FIGS. 6a and 6b are shown in FIGS. 7a and 7b respectively. The finger here functions as a hook. The frame is brought into contact with the upper side of the flat cementitious material reinforcement products 900, similarly as was shown in FIG. 4a. the position of the moveable carrying means 205 and hence the supporting surface 120, is first adjusted by making a first movement being a translation in the direction 210 towards the opening 901. Once the required position is achieved, the moveable finger makes a second movement being a rotation along an axis 221, whereby the supporting surface is rotated towards the edge of the opening 901 and being brought under the lower side of the flat cementitious material reinforcement product 900, in this embodiment under the rebar defining the edge of the opening. Similarly as set out for the embodiment relating to FIGS. 4a to 4c, the device may lift the flat cementitious material reinforcement product 900, and similar consecutive movements and steps may be taken to move this flat cementitious material reinforcement products 900, and optionally to lift a next flat cementitious material reinforcement product 900.

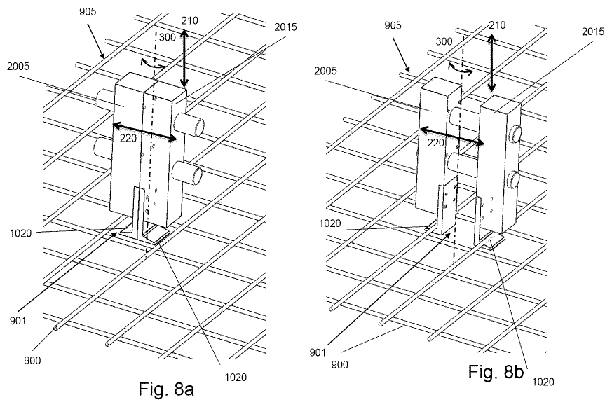

Still a detail of an alternative supporting element is shown in FIGS. 8a and 8b. Each supporting element comprises two parallel moveable fingers 2005 and 2015, each having a supporting surface 1020 at their outer end. The frame is brought into contact with the upper side of the flat cementitious material reinforcement products 900, similarly as was shown in FIG. 4a. The position of the moveable fingers 2005 and 2015 are such that the supporting surfaces 1020 fit into the opening 901. By making a first movement being a translation in the direction 210 towards and into the opening 901, the supporting surfaces 1020 are brought to a position lower than the lower side of the flat cementitious material reinforcement product 900. Once the required position is achieved, the moveable fingers make a second movement being a translation in the direction 220. Each of the supporting surfaces is moved towards the edge the surface is oriented to. Hence the second movements, both being a translation in the direction 220, are made in opposite direction. The supporting surfaces are brought under the lower side of the flat cementitious material reinforcement product 900, in this embodiment under the rebar defining the edge of the opening, as shown in FIG. 8b. Similarly as set out for the embodiment relating to FIGS. 4a to 4c, the device may lift the flat cementitious material reinforcement product 900, and similar consecutive movements and steps may be taken to move this flat cementitious material reinforcement products 900, and optionally to lift a next flat cementitious material reinforcement product 900.

In particularly when the flat cementitious material reinforcement product 900 are rebar meshes, the set of two fingers 2005 and 2015 may be rotationally mounted, whereby they may rotate at least 90° round an axis 300. As such the two surfaces 1020 of the fingers 2005 and 2015 may be brought into contact with the lower side of rebars in either one of the two directions in which the rebars are present in the rebar mesh.

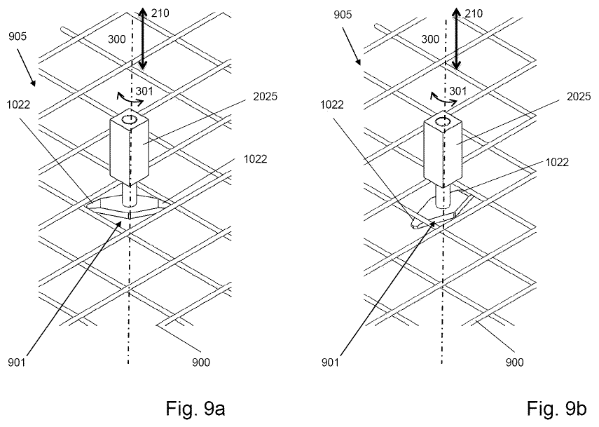

Details of an alternative supporting element is shown in FIGS. 9a and 9b. Each supporting element comprises a moveable finger 2025 having two mutually opposite supporting surface 1022 at their outer end. The frame is brought into contact with the upper side of the flat cementitious material reinforcement products 900, similarly as was shown in FIG. 4a. The position of the moveable finger 2025 is such that the supporting surfaces 1022 fit into the opening 901. By making a first movement being a translation in the direction 210 towards and into the opening 901, the supporting surfaces 1022 are brought to a position lower than the lower side of the flat cementitious material reinforcement product 900. Once the required position is achieved, the moveable fingers make a second movement being a rotation in a direction 301 of about 45° round an axis 300. As such the two supporting surfaces 1022 may be brought into contact with the lower side of the rebars defining a part of the edge of the opening 901. By tuning the position lower than the lower side of the flat cementitious material reinforcement product 900 for the supporting surfaces during the first movement, and the sense of the rotation during the second movement, two surfaces 1020 of the finger 2025 may be brought into contact with the lower side of rebars in either one of the two directions in which the rebars are present in the rebar mesh.

Similarly as set out for the embodiment relating to FIGS. 4a to 4c, the device may lift the flat cementitious material reinforcement product 900, and similar consecutive movements and steps may be taken to move this flat cementitious material reinforcement products 900, and optionally to lift a next flat cementitious material reinforcement product 900.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1. A device for lifting at least one flat cementitious material reinforcement product comprising a plurality of openings, the device comprising:
a hoisting frame suitable for being secured to a hoisting means, the hoisting frame comprising supporting elements each having at least one supporting surface adapted to support at least one flat cementitious material reinforcement product, each of said supporting elements being positioned in such a way that when the hoisting frame rests on this at least one flat cementitious material reinforcement product, each supporting element is located in or above a respective opening; said supporting elements are configured to perform at least a first and a second movement, said first movement being a movement in a first direction towards, in or into the opening of this at least one flat cementitious material reinforcement product, said second movement being a movement for positioning the supporting surface of said supporting element under this at least one flat cementitious material reinforcement product in such a way that during lifting of the device, the supporting elements support the at least one flat cementitious material reinforcement product.

2. The device according to claim 1, wherein the device comprises one or more contact means configured to be secured to the hoisting frame such that the hoisting frame rests on the flat cementitious material reinforcement product or products by means of the contact means prior to the supporting elements making said first movement.

3. The device according to claim 1, wherein said device comprises at least four supporting elements, at least 3 of said supporting elements being positioned such they are positioned at the corners of a polygon.

4. The device according to claim 1, wherein said first movement is a translational movement in a first direction into the opening.

5. The device according to claim 1, wherein said second movement is a translational movement in a second direction towards the edge of the opening.

6. The device according to claim 5, wherein the supporting elements each have a first and a second supporting surface, both adapted to support at least one flat cementitious material reinforcement product, both supporting surfaces are adapted to be brought under the flat cementitious material reinforcement product by a movement in the second direction, but in a different, mutually opposite sense.

7. The device according to claim 1, wherein said second movement is a rotational movement around an axis oriented in a third direction.

8. The device according to claim 7, wherein said first movement is a translational movement in a first direction into the opening, the third direction being identical or parallel to the first direction.

9. The device according to claim 7, wherein said first movement is a translational movement in a first direction into the opening, the third direction being perpendicular to the first direction.

10. The device according to claim 1, wherein the supporting elements are adapted to perform the first movement one independent from the other.

11. The device according to claim 1, wherein the supporting elements are adapted to perform the second movement one independent from the other.

12. The device according to claim 1, wherein the device comprises a first actuator for performing said first movement and a second actuator for performing said second movement.

13. The device according to claim 1, wherein the first actuator and the second actuator are mutually independently operating hydraulic actuators.

14. The device according to claim 1, wherein at least one dimension of the contact means prevents the contact means to be able to pass in or into the opening of this at least one flat cementitious material reinforcement product.

15. The device according to claim 1, wherein the height of the contact means is adjustable.

16. The device according to claim 1, wherein the device comprises as much contact means as supporting elements.

17. The device according to claim 16, wherein adjacent to each of said supporting elements, one of said contact means is provided.

18. The device according to claim 16, wherein each contact means is located between two supporting elements.

19. The device according to claim 18, wherein each contact means is located between two supporting elements, and is closer to one of said two supporting elements.

20. The device according to claim 18, wherein each contact means is located between two supporting elements such the two supporting elements and said contact means are colinear.

21. The device according to claim 16, wherein each contact means is located adjacent a supporting elements such the supporting elements second movement is directed away from the contact means.

22. A hoisting means comprising a device according to claim 1.

23. A method to move a flat cementitious material reinforcement product, the method comprises the steps of:
1) providing a stack of the flat cementitious material reinforcement product;
2) providing
a device according to claim 1 and connecting this device to a hoisting means, or
3) contacting the device to the upper surface of the upper flat cementitious material reinforcement product in the stack of flat cementitious material reinforcement product;
4) adjusting the position of some or all the supporting elements by making said first movement;
5) making the second movement for some or all the supporting elements;
6) lifting the device, while this device is supporting at least this upper flat cementitious material reinforcement product.

24. The method according to claim 23, the method further comprises the steps:
7) move the lifted device, to a position on a construction yard;
8) lower the device and release the lifted flat cementitious material reinforcement product or products;
9) lift the device and move it back to the remainder of the stack of the flat cementitious material reinforcement product;
10) contacting the device to the upper surface of the upper flat cementitious material reinforcement product in the stack of flat cementitious material reinforcement product;
11) optionally adjusting the position of some or all the supporting elements by making said first movement;
12) making the second movement for some or all the supporting elements;
13) lifting the device, while this device is supporting at least this upper flat cementitious material reinforcement product;
14) optionally iterate steps numbered 7 to 13 until all flat cementitious material reinforcement product or products of the stack of flat cementitious material reinforcement products are moved.
